(19) United States
(12) Patent Application Publication
(10) Pub. No.: US 2007/0045595 A1
(43) Pub. Date: Mar. 1, 2007

(54) Capacitative element, integrated circuit and electronic device

(75) Inventor: Masao Kondo, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/590,768

(22) Filed: Nov. 1, 2006

Related U.S. Application Data
(63) Continuation of application No. PCT/JP04/08561, filed on Jun. 11, 2004.

(51) Int. Cl. H01B 1/12

(52) U.S. Cl. 252/500

(57) ABSTRACT

The present invention provides a capacitive element comprising BiFeO₃ having particular cations other than Bi ions or Fe ions at the Bi ion sites or Fe ion sites of a crystal lattice, along with an electronic device and the like using that capacitive element. According to the present invention, it is possible to achieve a high-performance electronic device which has a large recording density and which is environmentally friendly because it contains no lead.

### CROSS REFERENCE TO RELATED APPLICATIONS

This application is a continuation of International Application No. PCT/JP2004/008561, filed on Jun. 11, 2004, now pending, herein incorporated by reference.

### TECHNICAL FIELD

The present invention relates to a capacitive element for use in non-volatile semiconductor memories and the like.

### BACKGROUND ART

It is expected that non-volatile memories (FeRAM) using ferroelectrics with spontaneous polarization for the capacitor part will be applied as next-generation memories to non-contact IC cards and the like. This kind of capacitor is desirable from a practical standpoint because it allows for a wider operating margin, the greater the amount of polarization is.

At present, PZT (lead zirconate titanate: PbZr₁₋ₓTiₓO₃) materials are used as ferroelectric capacitor materials for obtaining large polarization. PZT is an oxide containing lead, and since lead is a toxin that accumulates in the human body it is desirable that its use be reduced as much as possible.

Many layered oxides and simple perovskite complex oxides containing Bi are known as ferroelectric materials that contain no lead, but these provide less polarization than PZT. In recent years, however, it has been reported that BiFeO₃ may be a ferroelectric material with polarization properties equal to or greater than those of PZT (Science, Vol. 299, 2003, p. 1719). Moreover, the Curie temperature of BiFeO₃ is 850° C., higher than the Curie temperature of PZT (230-540° C.). The temperature range in which the ferroelectric state holds is wider, the higher its Curie temperature is, allowing for a wider operating temperature range, which is desirable from a practical standpoint.

### DISCLOSURE OF THE INVENTION

However, BiFeO₃ has a large leakage current for a ferroelectric material, and by itself cannot provide a highly reliable capacitor. It is an object of the present invention to reduce the leakage current of BiFeO₃ while maintaining a Curie temperature higher than that of PZT, thereby providing a high-performance, high-capacity capacitive element containing no lead, along with an integrated circuit, semiconductor device and other electronic devices having this element.

One group of aspects of the present invention provide a capacitive element comprising BiFeO₃ having trivalent cations other than Bi ions or Fe ions at the Bi ion sites or Fe ion sites of a crystal lattice, along with an integrated circuit and electronic device using the capacitive element.

Another group of aspects of the present invention provide a capacitive element containing BiFeO₃ having cations of at least one kind selected from the group consisting of Al ions, Sc iosn, Ga ions, In ions, Ce ions, Pr ions, Nd ions, Pm ions, Sm ions, Eu ions, Gd ions, Tb ions, Dy ions, Ho ions, Er ions, Tm ions, Yb ions and Lu ions at the Bi ion sites or Fe ion sites of a crystal lattice, along with an integrated circuit and electronic device using the capacitive element.

It is desirable that 30 mole % or less of the Bi ion sites of the crystal lattice be occupied by these cations, that 30 mole % or less of the Fe ion sites of the crystal lattice be occupied by these cations, that these cations constitute 30 mole % or less of the total cations in the BiFeO₃, that given that the total of all Fe ions and all such cations substituted for Fe ions be 100 mole parts, the total of all Bi ions and all such cations substituted for Bi ions be 110 mole parts or less, that the underlayer electrode of the capacitive element be of a platinum group metal, an oxide of a platinum group metal or a conductive oxide having a simple perovskite structure, and that the integrated circuit or electronic device be provided with the capacitive element and a transistor or have the capacitive element formed on the gate oxide film of a transistor.

With the present invention it is possible to achieve a high-performance semiconductor device or other electronic device with a large recording density which is environmentally friendly because it contains no lead.

### BRIEF DESCRIPTION OF THE DRAWINGS

FIG. 1 is a model view showing a simple perovskite crystal structure;

FIG. 2 is a model cross-section of a 1C1T type ferroelectric memory part;

FIG. 3 is a model cross-section of an FET type ferroelectric memory part;

FIG. 4 is a model view showing cations of a different kind incorporated into some of the A sites of a simple perovskite crystal structure of BiFeO₃;

FIG. 5 is a model view showing a different cation incorporated into the B site of a simple perovskite crystal structure of BiFeO₃; and

FIG. 6 is a graph showing various leakage characteristics.

### DESCRIPTION OF THE PREFERRED EMBODIMENTS

Embodiments of the present invention are explained below using figures, examples and the like. These figures, examples and the like and explanations exemplify the present invention but do not limit its scope. Other embodiments can of course be included in the scope of the present invention to the extent that they match the intent of the present invention.

BiFeO₃ assumes a simple perovskite structure represented by ABO₃, wherein Bi corresponds to A and Fe to B. A combination of Bi³⁺ and Fe³⁺ is standard, and if a valence other than plus trivalent is taken, there will be more lattice defects in the crystal and the leakage current will be likely to increase. Fe ions in particular are prone to assume a plus bivalent state. Also, because bismuth oxide has a low melting point of 817° C. and tends to evaporate when heated, it is likely to be lost from sites in the perovskite structure during the crystallization process. Increase in the amount of loss will result in formation of a hetero-phase that is not ferroelectric, causing the leakage current to increase.

It has been found that leakage current can be reduced in the case of a capacitive element comprising, as a ferroelectric substance, BiFeO₃ having cations of at least one kind selected from the group consisting of Al ions, Sc ions, Ga ions, In ions, Ce ions, Pr ions, Nd ions, Pm ions, Sm ions, Eu ions, Gd ions, Tb ions, Dy ions, Ho ions, Er ions, Tm ions, Yb ions and Lu ions at the Bi ion sites or Fe ion sites of the crystal lattice. Al ions, Sc ions, Ce ions, Dy ions and Gd ions are particularly desirable.

The presence or absence of these ions at the Bi ion sites or Fe ions sites of the crystal lattice can be evaluated by first confirming the element contents by fluorescent x-ray analysis or other composition analysis, and then determining the lattice constant of the perovskite structure by x-ray diffraction. Since the substituted elements have different ion radii from that of the Fe or Bi ions, the lattice constant will be larger if an ion with a larger radius is substituted and smaller if an ion with a smaller radius is substituted. When forming a ferroelectric by metalorganic chemical vapor deposition (MOCVD) or the like for example using a raw material with a BiMFeO₃ composition (wherein M is an element of the present invention), the conditions of the present invention can be considered to be met if the M in the composition is able to be a cation source in the context of the present invention.

These cations are all unlikely to assume valency other than a trivalent state such as Al³⁺, Sc³⁺, Ga³⁺, In³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺ and Lu³⁺ and substitution of these cations for Bi ions at the Bi sites or Fe ions at the Fe sites serves to prevent the occurrence of a hetero-phase due to Bi ion loss in the lattice, thereby stabilizing the perovskite phase, or to reduce lattice defects by reducing the number of Fe ions which are liable to changes in ion valence. Moreover, addition of ions for substitution also has an effect of breaking up sequences of Fe ions that form leakage paths in the crystal.

In general, it appears that leakage current can be reduced with a capacitive element comprising BiFeO₃ having trivalent cations other than Bi ions or Fe ions, at Bi ion sites or Fe ions sites in the crystal lattice. XPS (x-ray photoelectron spectroscopy) can be used to determine whether the cations are trivalent. Elements capable of producing trivalent cations other than Bi ions or Fe ions are preferably elements other than the transitional elements (that is, d-block elements), such as for example lanthanoids or IIIA group elements, which are f-block elements. However, although Sc is a d-block element, it is suited to the purpose of the present invention because it is unlikely to be other than trivalent.

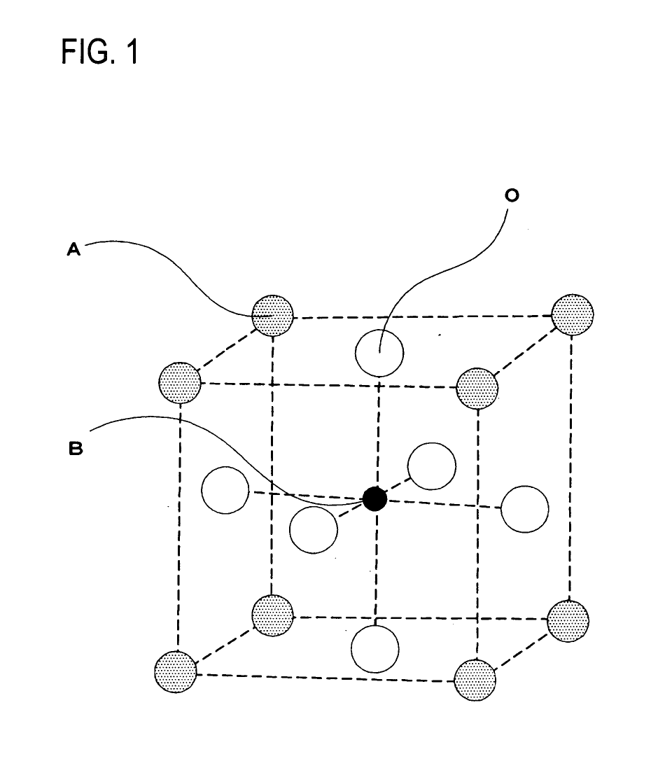

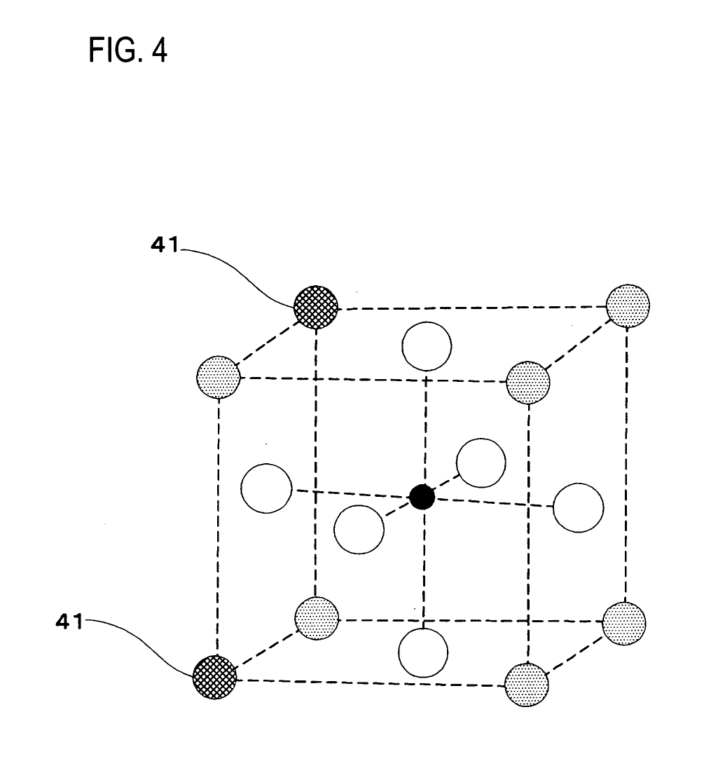

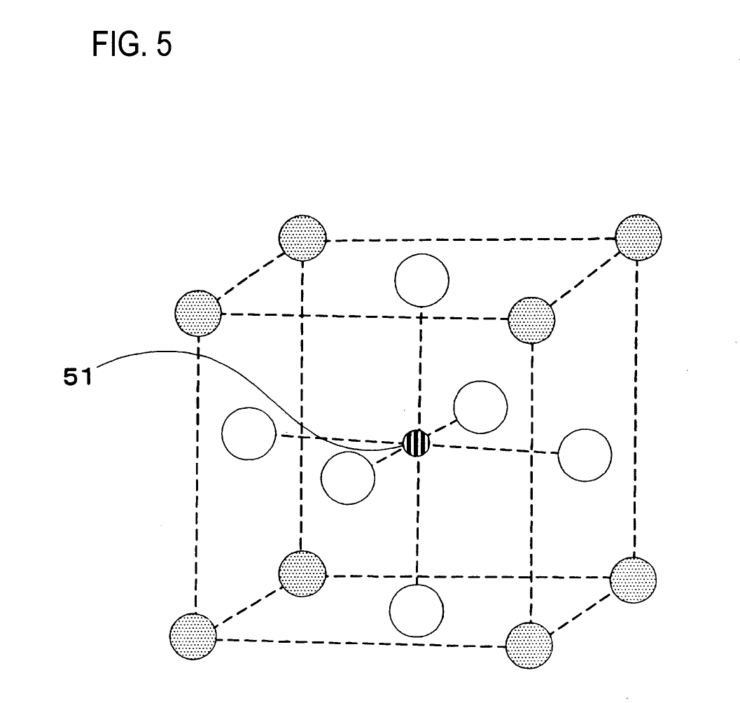

BiFeO₃ assumes a simple ABO₃ perovskite crystal structure as shown in FIG. 1. That is, A (Bi) occupies the sites at the 8 corners of a regular hexahedron, with B (Fe) in the center (body center), and O sites in the center of each of the 6 faces. O therefore forms a regular octahedron. The aforementioned cations are substituted for A or B. FIG. 4 shows cations 41 substituted at A positions, while FIG. 5 shows a cation 51 substituted at the B position.

Whether substitution occurs at A or B appears to be determined primarily by the ionic radius of the cation. Ions with large ion radii occupy A sites, while ions with small ion radii occupy B sites. Specifically, it is possible to consider that A sites are occupied in general if the ionic radius in octahedral coordination is 0.9 nm or more, while if the radius is smaller, B sites are occupied preferentially. More specifically, it is considered that, of Al³⁺, Sc³⁺, Ga³⁺, In³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺ and Lu³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺ and Lu³⁺ occupy A sites, while the others occupy B sites.

The cations added as described above may be of more than one kind. Moreover, the ferroelectric of a capacitive element of the present invention may also contain elements other than Bi, Fe and O as well as the aforementioned cations to the extent that they do not detract from the function of the capacitive element.

When the substitution amount of the cations of the present invention increases, the Curie temperature drops, as does the temperature range in which the ferroelectric state holds, and when a high-temperature process is included in the preparation of an electronic device comprising this capacitive element (such as when a high temperature of about 270° is required for solder reflowing), it will not be possible to write memory into the capacitive element before this process among other problems, and the polarization rate will be decreased at a temperature range of actual use.

Consequently, the aforementioned cations preferably constitute 30 mole % or less of the respective cations in the BiFeO₃. In other words, the percentage of these cations in the A sites and B sites of the ABO₃ crystal lattice is preferably 30 mole % or less of the respective sites. When it is not clear whether the cations are substituted for Bi or Fe, it is possible to consider that these cations preferably constitute 30 mole % or less of the total cations in the BiFeO₃. Specifically, M/(Bi+M+Fe) is 30 mole % or less in BiMFeO₃ (where M is the cation of the present invention). The same applies to BiMFeO₃ if O constitutes 3 mole parts of the BiMFeO₃ and Bi+M+Fe is stoichiometrically other than 2 mole parts, and it is not necessary to consider only the M actually present at the A and B sites. The lower limit is not particularly restricted and can be determined according to the actual needs in terms of leakage current level and Curie temperature.

In the case of pure BiFeO₃, the molar ratio of Fe ions to Bi ions is in principal 1:1, but since Bi is liable to be lost from the lattice the occurrence of a hetero-phase can be suppressed by adding an excess of Bi, thereby increasing the components having a simple perovskite structure. However, as the added excessive amount of Bi is increased, Bi₂O₃ is deposited at the grain boundaries, and the Bi₂O₃ precipitated at the grain boundaries forms leakage paths, resulting in the formation of hetero-phases (such as A₂B₄O₉) as defect sites, and increasing the leakage current. Therefore, it is believed that the upper limit is set by the increase in leakage current (due to the increase in the amount of added excessive Bi).

Such behavior is also seen in the capacitive element of the present invention, and it was judged that given 100 mole parts as the total of Fe ions and the cations substituted for Fe ions, the total of Bi ions and the cations substituted for Bi ions should be preferably 110 mole parts or less. In other words a (Bix, My)FeO₃ composition (wherein M is the element of the present invention and x+y≦1.1) is desirable. In this case also the lower limit is not particularly restricted and may be determined according to the actual needs in terms of leakage current level and Curie temperature, but in general if the total of Fe ions and the cations substituted for Fe ions is 100 mole parts the total of Bi ions and the cations substituted for Bi ions should be preferably 100 mole parts or more. There is no need to actually confirm that the added cations have been substituted for the Fe ions or Bi ions. It is enough that the aforementioned relationship be established in the composition. It is also not necessary to confirm whether the added cations have been substituted for the Fe ions or they have been substituted for Bi ions, since this can be evaluated based on the aforementioned ion radius.

There is no particular limit on the method of forming the BiFeO₃ containing the aforementioned cations, but doping by MOCVD, pulse laser deposition (PLD), chemical solution deposition (CSD) or the like can be used by preference.

Such a capacitive element will often be used as a ferroelectric layer sandwiched between an underlayer electrode and an upper electrode. In this case of a capacitive element, the underlayer electrode is formed first and the ferroelectric layer and upper electrode are then laminated thereon in that order. In this case, the underlayer electrode needs to withstand the high temperature (up to 70° C.) during oxygen annealing to restore damage (O loss, etc.) to the BiFeO₃ during preparation of the upper electrode. A platinum group metal or platinum group metal oxide or a conductive oxide with a simple perovskite structure can be used for this purpose.

Of these, platinum, iridium, ruthenium, iridium oxide, ruthenium oxide, SrRuO₃, LaNiO₃, (La,Sr)CoO₃, (La,Sr)MnO₃ and the like are more preferable for the purposes of improving the polarization characteristics of the ferroelectric. A conductive oxide with a simple perovskite structure is particularly desirable because there is little chemical interaction between the Bi or Fe and the underlayer electrode and consequently little fatigue in the capacitive element due to switching, but platinum, iridium, ruthenium, iridium oxide and ruthenium oxide are superior from the standpoint of ease of preparation.

In this way, the leakage current of a BiFeO₃ capacitive element can be reduced by reducing the defect density in the crystal while maintaining a high Curie temperature. As a result, it can be used favorably, as a capacitive element exploiting the high polarization of BiFeO₃, for example, as part of FeRAM, in integrated circuits in combination with transistors and other active devices, resistance, capacitors and other passive devices, multilayer wiring and the like. It can also be used favorably in electronic devices such as personal computers, smart cards, security cards, RFIC tags, portable telephones, PDAs and the like.

Typical examples of such electronic devices include electronic devices provided with the capacitive element and a transistor, as in the case of 1C1T (1 capacitor 1 transistor) FeRAM, and electronic devices in which the capacitive element is formed on the gate oxide film of a transistor, as in the case of FET (field effect transistor) FeRAM.

Examples of the present invention are given below.

### EXAMPLE 1

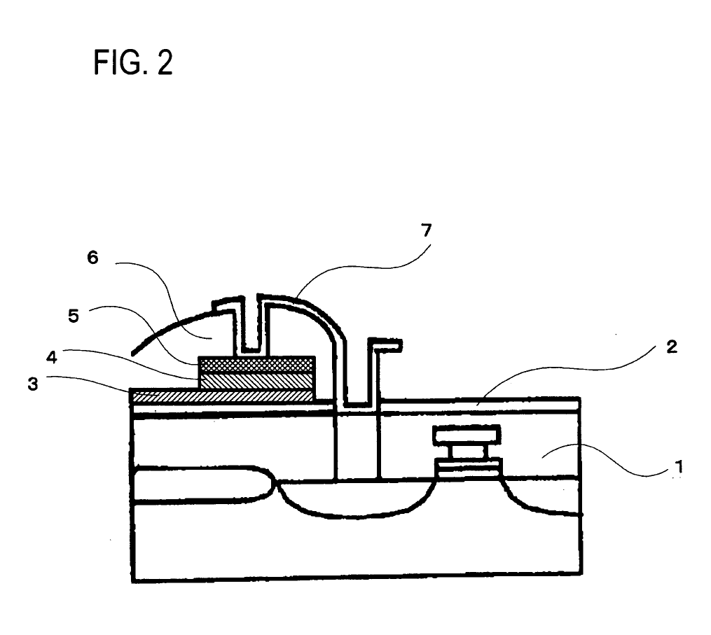

An electronic device (ferroelectric memory) having the structure of FIG. 2 can be manufactured by the following process. FIG. 2 is a model cross-section showing a 1C1T ferroelectric memory part.

(1) Silicon oxide film 2 is formed atop wafer 1 having a transistor formed thereon.

(2) A titanium oxide layer (not shown) as an adhesion layer and then a platinum layer as an underlayer electrode 3 are formed by sputtering.

(3) (Bi_{0.9}, Ce_{0.1})FeO₃ layer 4 is formed by MOCVD.

(4) A platinum layer is formed by vacuum deposition as an upper electrode 5.

(5) Patterning is then performed by photolithography.

(6) The whole is covered with silicon oxide film 6, and the upper electrode is taken to the surface to form a wiring layer 7.

### EXAMPLE 2

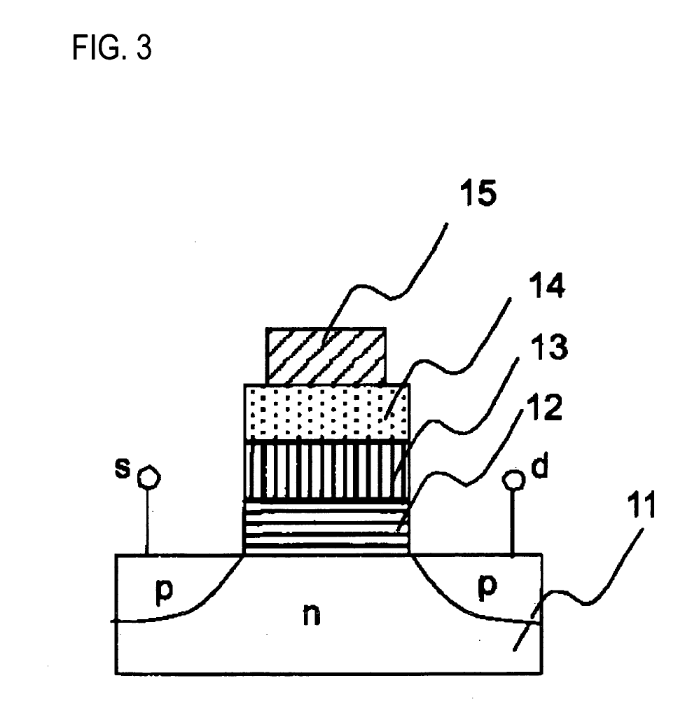

An electronic device (ferroelectric memory) having the structure of FIG. 3 can be manufactured by the following process. FIG. 3 is a model cross-section showing an FET ferroelectric memory part.

(1) Two inch silicon monocrystalline substrate 11 having (001) orientation is washed and soaked in 9% weight dilute hydrofluoric acid to remove the SiOₓ layer from the substrate surface.

(2) The silicon monocrystalline substrate is set in a film-forming chamber and maintained at an actual substrate temperature of 550° C., and a YSZ (yttrium stabilized zirconia) target is irradiated with a KrF excimer laser at a pressure of 7×10⁻² Pa in a 12 sccm flow of oxygen (gas flow per minute (mL/minute) at 20° C., 1 atmosphere) to epitaxially grow YSZ film 12 to 5 nm by pulse laser deposition.

(3) The crystal structure of the ferroelectric layer of the present invention can be directly formed on a YSZ film, but in that case the orientation will be (101) and the polarization will be reduced, so it is preferable to use another type of orientation. Therefore, switching to a strontium carbonate target, a 2 nm SrO film is grown epitaxially on the YSZ film by laser irradiation at 1.3 Pa in a 6 sccm flow of oxygen with the actual substrate temperature maintained at 650° C.

(4) The target is switched to strontium titanate, and strontium titanate film (STO) 13 is grown epitaxially on the SrO/YSZ film with (001) orientation to a thickness of 10 nm by laser irradiation at 27 Pa in a 6 sccm flow of oxygen. Because the SrO film is so thin it is incorporated into the strontium titanate film as it grows.

In this way a YSZ film and STO film are laminated atop a monocrystalline silicon substrate. In addition to serving as insulating layers and allowing the crystalline epitaxial growth of the ferroelectric layer of the present invention, these films serve to prevent chemical reaction of the Si with the Bi and Fe by intervening between the monocrystalline silicon substrate and the ferroelectric layer.

(5) The target is switched to Bi_{1.10}(Fe_{0.8}, Sc_{0.2})O₃ having excess added Bi, and a Bi_{1.10}(Fe_{0.8}, Sc_{0.2})O₃ layer 14 is grown epitaxially with (001) orientation to a thickness of 200 nm on the STO/YSZ film by laser irradiation at 27 Pa in a 6 sccm flow of oxygen.

(6) Platinum upper electrode film 15 is formed by electron beam deposition.

(7) This is etched by photolithography to the shape of the gate insulating film.

In this way, an MFIS (Metal-Ferromagnetic-Insulator-Semiconductor)-FET is obtained. In this case, the platinum of the upper electrode film is the M, the Bi_{1.10}(Fe_{0.8}, Sc_{0.2})O₃ is the F, and the STO/YSZ film is the I.

### EXAMPLE 3

A 1T1C ferroelectric memory can be obtained as in Example 1 by forming a (Bi_{0.8}, Nd_{0.2})FeO₃ layer or a Bi (Fe_{0.9}Sc_{0.1})O₃ layer in place of the (Bi_{0.9}, Ce_{0.1})FeO₃ layer.

### EXAMPLE 4

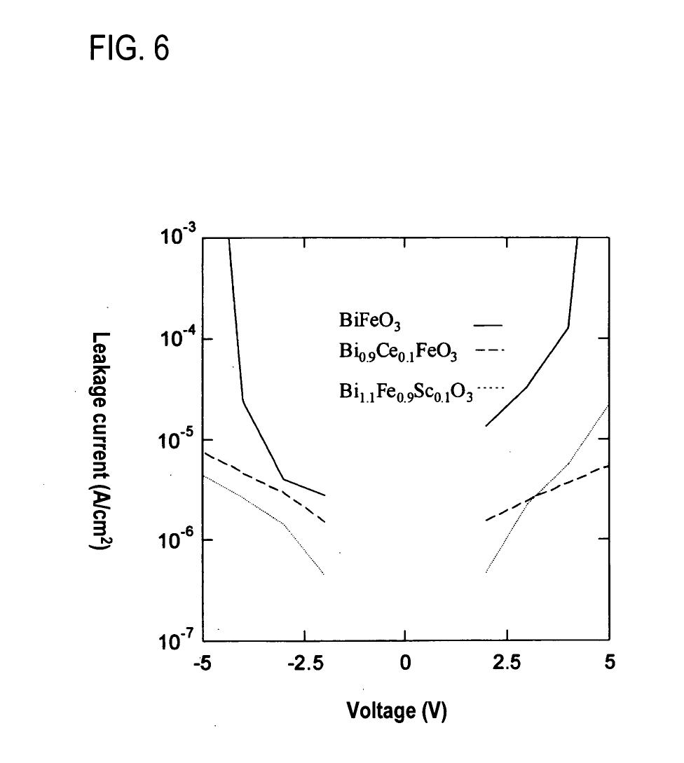

Ferroelectric capacitors of the present invention were prepared by the following process, and their leakage current characteristics were evaluated. The results are shown in FIG. 6.

(1) Titanium was formed as the adhesive layer on a silicon oxide film, and a platinum layer was then formed to 100 nm by sputtering with heating at 500° C. as the underlayer electrode.

(2) The substrate was set in a film-forming chamber and maintained at an actual substrate temperature of 500° C., and a BiFeO₃, Bi_{0.9}Ce_{0.1}FeO₃, Bi_{1.1}Fe_{0.9}Sc_{0.1}O₃ or Bi_{1.2}Fe_{0.9}Sc_{0.1}O₃ target was irradiated with a Nd:YAG laser (355 nm) in a 6 sccm flow of oxygen at a pressure of 47 Pa, to form each film by pulse laser deposition to 300 nm each on a separate substrate.

(3) A platinum layer was formed by vacuum deposition as the upper electrode.

The leakage currents for the respective compositions are shown in FIG. 6. The conventional BiFeO₃ had a high leakage current, and could not function as a capacitor at voltages of 5 V or more. The leakage currents of the Bi_{0.9}Ce_{0.1}FeO₃ and Bi_{1.1}Fe_{0.9}Sc_{0.1}O₃ of the present invention were lower than that of BiFeO₃, and withstood voltages of 5 V or more. The inclination of leakage current of the Bi_{1.1}Fe_{0.9}Sc_{0.1}O₃ tended to be larger than that of the Bi_{0.9}Ce_{0.1}FeO₃ on the plus side. This tendency further increased when the Bi content was increased still further, indicating the formation of new leakage paths. The Bi_{1.2}Fe_{0.9}Sc_{0.1}O₃ film had a large leakage current, indicating a limit on its ability to function as a capacitor. This is attributed to precipitation of bismuth oxide at the film's grain boundaries. Thus, the excess at the A sites is preferably limited up to 110 mole parts per 100 mole parts at the B sites.

Since it was difficult to derive the Curie temperature of the present invention directly from the dielectric constant temperature characteristic, the ferroelectric phase was distinguished from the paraelectric phase by means of the diffraction pattern obtained from x-ray diffraction analysis with the temperature varied. At temperatures near the Curie temperature it is difficult to distinguish the ferroelectric phase from the paraelectric phase even by x-ray diffraction analysis because the diffraction peak is so broad, but Bi_{0.9}Ce_{0.1}FeO₃ had a ferroelectric phase at least at 700° C. by x-ray analysis. The Curie temperature varies in a roughly linear fashion with the amount of substitution. Supposing 700° C. to be the Curie temperature, since the Curie temperature of unsubstituted BiFeO₃ is 850° C., the Curie temperature should fall by about 150° C. with each 10 mole % of substitution. Therefore, if the substitution rate is 30 mole %, the Curie temperature is estimated to be about 400° C. The Curie temperature of a typical lead-based ferroelectric PZT is 230° C. to 490° C. depending on the composition, and PZT materials having Curie temperatures of about 300 to 400° C. are used in FRAM. Consequently, it is more preferably that the amount of substitution is 30 mole % or less in order to maintain a Curie temperature higher than that of PZT.

### INDUSTRIAL APPLICABILITY

A high-performance electronic device which has a large recording density and which is environmentally friendly because it contains no lead can be achieved by the present invention.

1. A capacitive element, comprising BiFeO₃ having trivalent cations other than Bi ions or Fe ions at the Bi ion sites or Fe ion sites of a crystal lattice.

2. A capacitive element, comprising BiFeO₃ having cations of at least one kind selected from the group consisting of Al ions, Sc ions, Ga ions, In ions, Ce ions, Pr ions, Nd ions, Pm ions, Sm ions, Eu ions, Gd ions, Tb ions, Dy ions, Ho ions, Er ions, Tm ions, Yb ions and Lu ions at the Bi ion sites or Fe ions sites of a crystal lattice.

3. The capacitive element according to claim 1, wherein said cations occupy 30 mole % or less of the Bi ion sites of said crystal lattice.

4. The capacitive element according to claim 1, wherein said cations occupy 30 mole % or less of the Fe ion sites of said crystal lattice.

5. The capacitive element according to claim 1, wherein said cations constitute 30 mole % or less of the total cations in said BiFeO₃.

6. The capacitive element according to claim 1, wherein given that the total of Fe ions and said cations substituted for Fe ions is 100 mole parts, the total of Bi ions and said cations substituted for Bi ions is 110 mole parts or less.

7. The capacitive element according to claim 1, having a platinum group metal, platinum group metal oxide or conductive oxide with a simple perovskite structure as an underlayer electrode of said capacitive element.

8. An integrated circuit, provided with a capacitive element comprising BiFeO₃ having trivalent cations other than Bi ions or Fe ions at the Bi ion sites or Fe ion sites of a crystal lattice.

9. An integrated circuit, provided with a capacitive element comprising BiFeO₃ having cations of at least one kind selected from the group consisting of Al ions, Sc ions, Ga ions, In ions, Ce ions, Pr ions, Nd ions, Pm ions, Sm ions, Eu ions, Gd ions, Tb ions, Dy ions, Ho ions, Er ions, Tm ions, Yb ions and Lu ions at the Bi ion sites or Fe ions sites of a crystal lattice.

10. The integrated circuit according to claim 8, wherein said cations occupy 30 mole % or less of the Bi ion sites of said crystal lattice.

11. The integrated circuit according to claim 8, wherein said cations occupy 30 mole % or less of the Fe ion sites of said crystal lattice.

12. The integrated circuit according to claim 8, wherein said cations constitute 30 mole % or less of the total cations in said BiFeO₃.

13. The integrated circuit according to claim 8, wherein given that the total of Fe ions and said cations substituted for Fe ions is 100 mole parts, the total of Bi ions and said cations substituted for Bi ions is 110 mole parts or less.

14. The integrated circuit according to claim 8, having a platinum group metal, platinum group metal oxide or conductive oxide with a simple perovskite structure as an underlayer electrode of said capacitive element.

15. The integrated circuit according to claim 8, comprising said capacitive element and a transistor.

16. The integrated circuit according to claim 8, wherein said capacitive element is formed on the gate oxide film of a transistor.

17. An electronic device, provided with a capacitive element comprising BiFeO₃ having trivalent cations other than Bi ions or Fe ions at the Bi ion sites or Fe ion sites of a crystal lattice.

18. An electronic device, provided with a capacitive element comprising BiFeO₃ having cations of at least one kind selected from the group consisting of Al ions, Sc ions, Ga ions, In ions, Ce ions, Pr ions, Nd ions, Pm ions, Sm ions, Eu ions, Gd ions, Tb ions, Dy ions, Ho ions, Er ions, Tm ions, Yb ions and Lu ions at the Bi ion sites or Fe ions sites of a crystal lattice.

19. The electronic device according to claim 17, comprising said capacitive element and a transistor.

20. The electronic device according to claim 17, wherein said capacitive element is formed on the gate oxide film of a transistor.
